(19) United States
(12) Patent Application Publication
(10) Pub. No.: US 2006/0060311 A1
(43) Pub. Date: Mar. 23, 2006

(54) Slat structure for venetian blinds

(75) Inventor: Ben Hsu, Changhua Hsien (TW)

Correspondence Address: TROXELL LAW OFFICE PLLC, SUITE 1404, 5205 LEESBURG PIKE, FALLS CHURCH, VA, 22041, US

(73) Assignee: Ching Feng Blinds Ind. Co., Ltd.

(21) Appl. No.: 10/985,970

(22) Filed: Nov. 12, 2004

(30) Foreign Application Priority Data
Sep. 22, 2004 (TW) 093215126

(51) Int. Cl. E06B 3/12

(52) U.S. Cl. 160/236

(57) ABSTRACT

A slat structure for Venetian blinds includes a Venetian blind made up of rope ladders suspended between an upper and lower beams for supporting a plurality of blind slats located in an equal space thereto, and a pull cord led through cord-passage holes of the blind slats thereof respectively before wound around a pulley seat mounted at one end of the upper beam to hang downwards there-from so as to raise or lower the blind slats thereby wherein each blind slat is made in a hollow shape with a ventilation hole formed at the inner side thereof for better heat dissipation and insulation effects thereby, and the ventilation hole thereof has a plurality of vertically-extending support guide ribs properly disposed therein and integrally connected with the upper and lower inner walls thereof so as to provide a reinforcing support effect thereby. The walls defining the ventilation hole and the support guide ribs thereof are made in thin plates, which makes the Venetian blind lighter in weight for easier transportation and effortless assembly thereof. Besides, the ventilation hole and the support guide ribs thereof are integrally made as a whole, facilitating a simpler and speedier processing thereof to reduce the cost of production for more competitive power on the market as well as maintaining a neat and smooth surface of the blind slats without the sediment of dirt accumulated thereto so as to achieve the best using condition thereof.

### BACKGROUND OF THE INVENTION

The present invention is related to a slat structure for Venetian blinds, including a Venetian blind made up of rope ladders suspended between an upper and lower beams for supporting a plurality of blind slats located in an equal space thereto, and a pull cord wound around a pulley seat mounted at one end of the upper beam before hanging downwards there-from to raise or lower the blind slats thereby wherein each blind slat is made in a hollow shape with a ventilation hole and a plurality of vertically-extending support guide ribs properly disposed at the inner side thereof for better heat dissipation and insulation effects thereby. Besides, the walls defining the ventilation hole and the support guide ribs thereof are integrally molded in thin plates, which makes the Venetian blind lighter in weight for easier transportation and effortless assembly thereof, and facilitates a simpler and speedier processing thereof to reduce the cost of production as well as maintaining a neat and smooth surface of the blind slats without the sediment of dirt accumulated thereto so as to achieve the best using condition thereof.

Please refer to FIG. 1. A conventional blind slat structure includes a Venetian blind 10 having rope ladders 13 suspended between an upper and lower beams 11, 12 for supporting a plurality of blind slats 14 located in an equal space thereto wherein each blind slat 14 is made in a solid thick board as shown in FIG. 2. A pull cord 15 is sequentially led through cord-passage holes 141 of the blind slats 14 respectively, and the upper end of the pull cord 15 is wound around a pulley seat 111 mounted at one end of the upper beam 11 therein to suspend downwards there-from so as to control the lifting or expanding of the blind slats 14 thereby.

There are some drawbacks to such conventional blind slat structure. First, the blind slat 14, made in a solid thick board, is provided with a certain weight, which can relatively increase the total weight of the Venetian blind 10 and makes the transportation or assembly thereof more difficult and inconvenient to be done. Second, when the blind slats 14 of the Venetian blind 10, fully expanded to screen sunlight, are affected by the heat of sun, the hot air will totally concentrate on the blind slats 14 that, made in solid thick boards and unable to properly dissipate the heat thereof, not only tend to get hardened easily with a shortened lifetime thereof, but can increase the temperature indirectly and result in a stuffy and uncomfortable feeling indoors, failing to provide a heat insulation effect thereof. Third, over long time of exposure to the glaring sunlight without proper dissipation of the heat thereof, the blind slats 14 of the Venetian blind 10 can easily get warped out of shape due to the overheating by the sun and are unable to be levelly expanded for sunscreen or privacy purpose thereof.

Please refer to FIG. 3 showing a single slat of another conventional blind slat structure. A blind slat 10′ is made up of a central through hole 11′ disposed at the inner side thereof for the accommodation of a support plate 12′ therein wherein the support plate 12′ is equipped with a plane edge 121′ extending at the middle section thereof to be mutually abutted against the central through hole 11′ thereby, and a plurality of consecutive V-shaped folding edges 122′ symmetrically extending at both sides of the plane edge 121′ respectively to form a series of sharp-pointed wavy edges for supporting both lateral sides of the through hole 11′ thereof, permitting wind and air to flow through the central through hole 11′ for the dissipation of heat thereof.

There are some disadvantages to the second blind slat structure. First, the support plate 12′ is accommodated into the central through hole 11′ of each slat 10′ thereof, which, relatively increasing the total weight of the Venetian blind as a whole, tends to make the transportation and assembly of the Venetian blind thereof rather uneasy and inconvenient. Second, the slat 10′ is sustained by the support plate 12′ adapted at the central through hole 11′ therein to provide a proper stiffness for use, and the support plate 12′ must be individually processed before mounted and fastened to the finished slat 10 thereof, which, complicated and time-consuming in the process, can increase the cost of material as well as production thereof. Third, the support plate 12′ is fixed at the central through hole 11′ of the slat 10′ therein. In case of inaccurate attachment to the inner wall of the through hole 11′ thereof, the support plate 12′ tends to get loosened and protruded outside the through hole 11′ after the repeated raising or lowering of the slat 10′ thereof, destroying the total beauty of the Venetian blind as a whole and causing the inconvenience thereof in practical use.

Please refer to FIG. 4 showing a third conventional blind slat structure. A slat 10″ is provided with a through hole 11″ disposed at the inner side thereof wherein a series of folded support ribs 12″ each having a folding edge 121′ defined thereon are integrally bent from the outer side of one lateral sidewall of the through hole 11″ to extend vertically inwards till abutted against the other lateral sidewall of the through hole 11″ thereof, permitting wind and air to flow at the through hole 11″ therein for dissipation of heat thereof.

However, the third conventional blind slat structure also includes some drawbacks. First, the folded support ribs 12″, each stacked up into layers, are doubled up in thickness, which can increase the weight of the slat 10″ and make the transportation and assembly of the Venetian blind thereof rather uneasy and inconvenient. Second, the central through hole 11″ of the slat 10″ is integrally and sequentially bent inwards from the outer side of one lateral sidewall thereof to form the folded support ribs 12″, which, rather complicated and tedious in the process thereof, can uneconomically increase the cost of production and inefficiently reduce the competitive power thereof. Third, the folded support ribs 12″ of the slat 10″ are integrally bent inwards in a sequence with a plurality of the folding edges 121″ formed at the surface thereon, which not only destroys the neatness and the total beauty of the Venetian blind thereof, but tends to accumulate tiny dust or stones therein and results in the difficulty and inconvenience of cleaning thereof.

### SUMMARY OF THE PRESENT INVENTION

It is, therefore, the primary purpose of the present invention to provide a slat structure for Venetian blinds, including a Venetian blind made up of rope ladders suspended between an upper and lower beams for supporting a plurality of blind slats located in an equal space thereto wherein each blind slat is made in a hollow shape with a ventilation hole and a plurality of vertically-extending support guide ribs formed at the inner side thereof for better heat dissipation and insulation effects without the risk of getting hardened or deformed due to overheating by the sun so that the slats thereof can be neatly kept in good shape and evenly expanded in a smooth manner. Besides, the ventilation hole and the support guide ribs thereof are integrally molded in thin plates so as to make the Venetian blind lighter in weight for easier transportation and effortless assembly thereof.

It is, therefore, the second purpose of the present invention to provide a slat structure for Venetian blinds wherein the ventilation hole and the support guide ribs thereof are integrally made as a whole to facilitate a simpler and speedier processing thereof, economically reducing the cost in a standardized production and boosting the competitive power thereof on the market.

It is, therefore, the third purpose of the present invention to provide a slat structure for Venetian blinds wherein the slat with the ventilation hole and the support guide ribs integrally made in the processing thereof can maintain a smooth and neat surface without the sediment of dirt accumulated thereon and can avoid the disadvantage of a support plate getting loosened from the slat as shown in the second conventional blind slat structure so as to achieve the best using condition thereof.

### BRIEF DESCRIPTION OF THE DRAWINGS

FIG. 1 is a perspective view of a conventional blind slat structure.

FIG. 2 is a partial and cross sectional view of the conventional blind slat structure.

FIG. 3 is a cross sectional view of a single slat of another convention blind slat structure.

FIG. 4 is a cross sectional view of a single slat of a third conventional blind slat structure.

FIG. 5 is a perspective view of the present invention.

FIG. 6 is a diagram showing the dissipation of heat from a slat of the present invention in practical use.

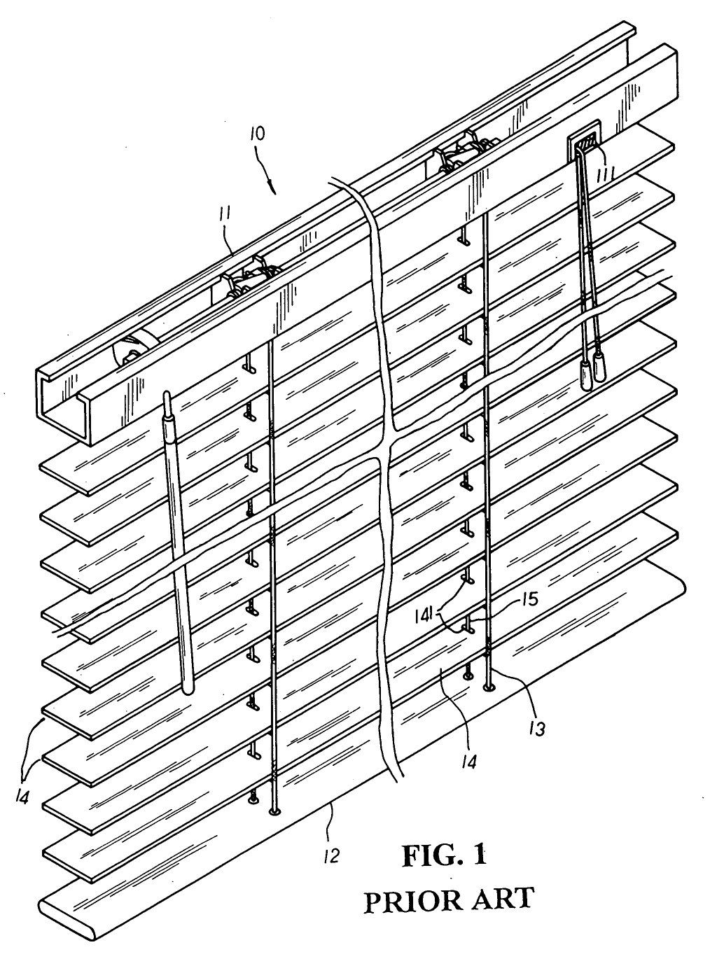

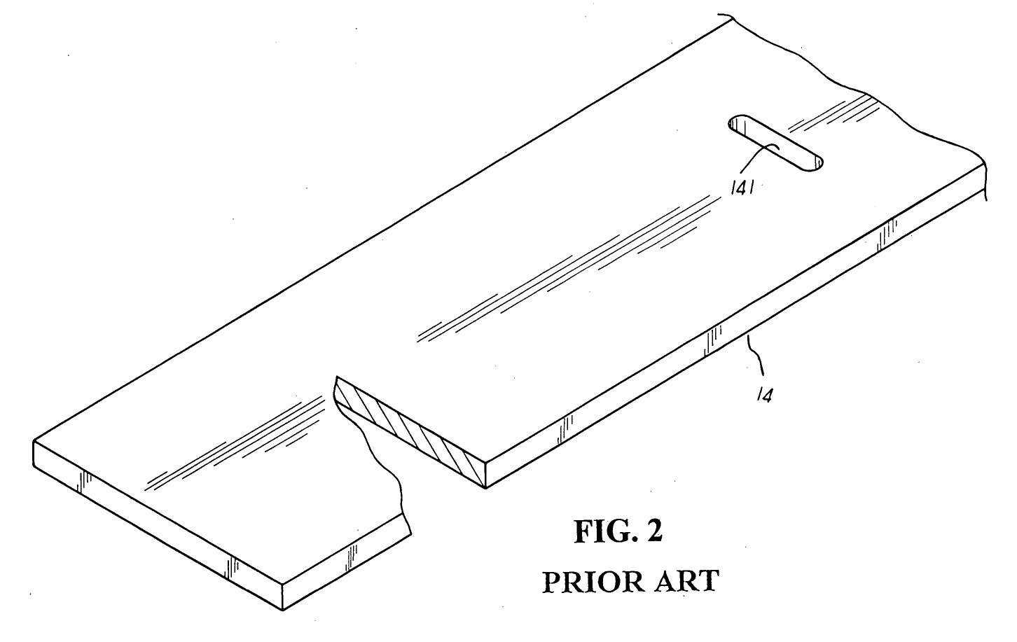

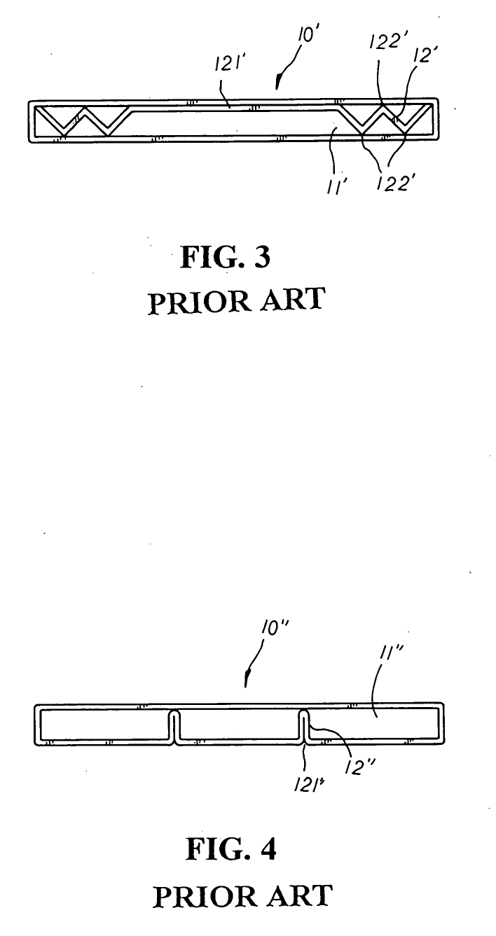

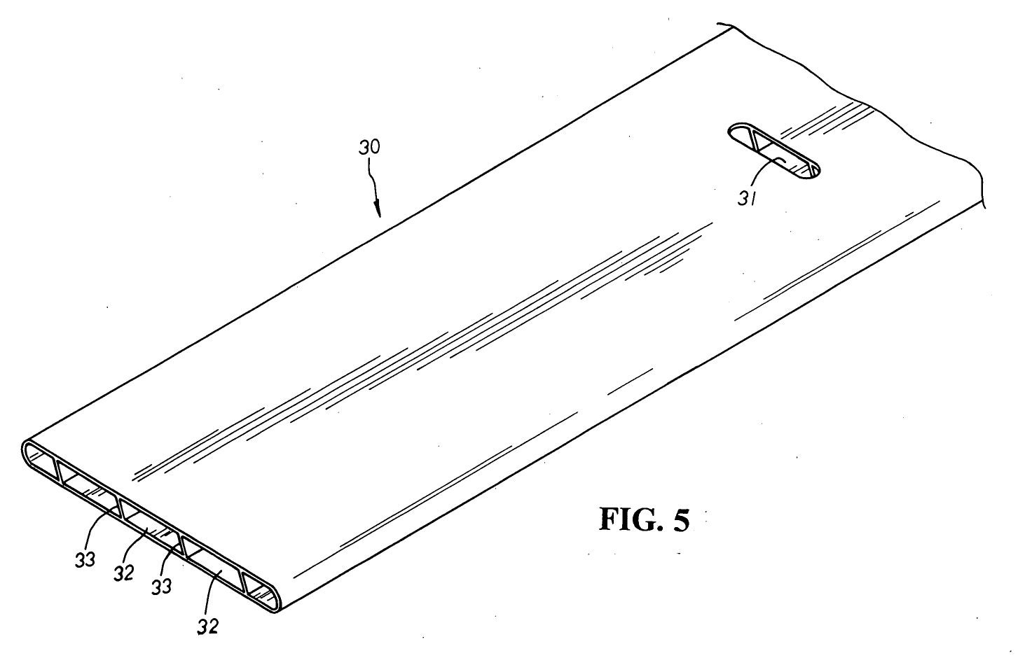

### DETAILED DESCRIPTION OF THE PREFERRED EMBODIMENTS

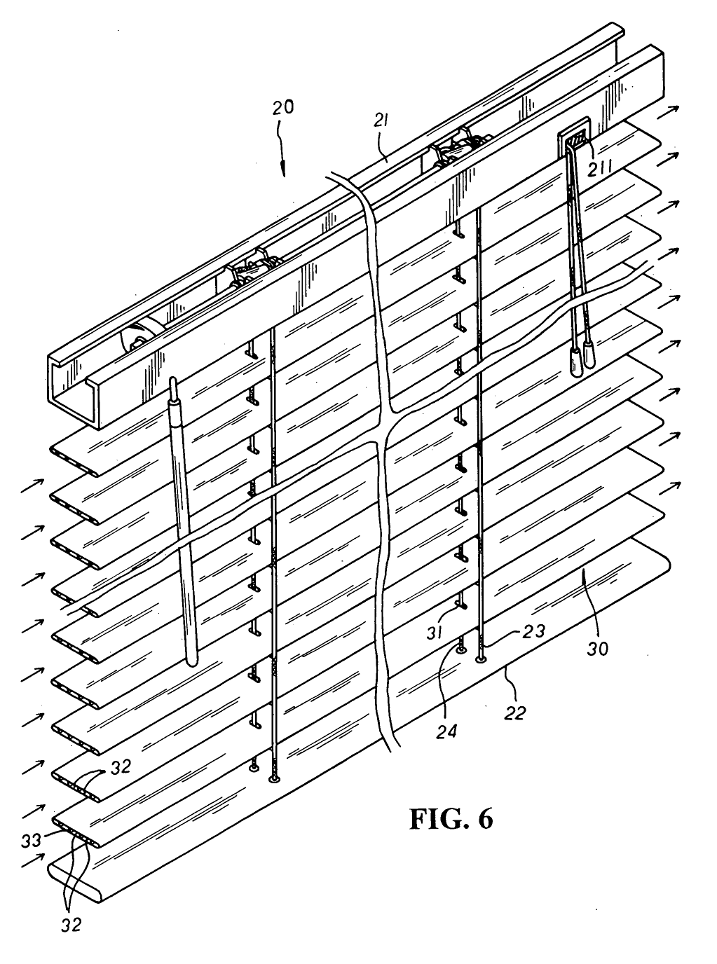

Please refer to FIGS. 5 to 6 inclusive. The present invention is related to a slat structure for Venetian blinds, including a Venetian blind 20 having rope ladders 23 suspended between an upper and lower beams 21, 22 for supporting a plurality of blind slats 30 located in an equal space thereto. A pull cord 24 is led through cord-passage holes 31 of each blind slat 30 thereof respectively, and the upper end of the pull cord 24 is wound around a pulley seat 211 mounted at one end of the upper beam 21 therein before hanging downwards there-from so as to control the lifting or expanding of the blind slats 30 thereby. Each blind slat 30 is made in a hollow shape and defined by a ventilation hole 32 disposed at the inner side thereof. A plurality of vertically-extending support guide ribs 33 is properly disposed at the ventilation hole 32 therein and integrally connected with the upper and lower inner walls of the ventilation hole 32 thereof so as to provide a reinforcing support effect thereby. Therefore, when the blind slats 30 of the Venetian blind 20 are fully expanded to screen the light and heat of sun, the ventilation holes 32 disposed at the inner side of the blind slats 30 thereof can allow wind and air to openly flow along the support guide ribs 33 and freely ventilate therein so as to properly dissipate the heat gathered at the surface of the blind slats 30 as shown in FIG. 6, efficiently achieving better insulation effect thereof. Besides, the blind slats 30 can also avoid the risk of hardening or warping due to the overheating by the sun, which can not only prolong their lifetime in use but also keep each blind slat 30 in good shape so that the blind slats 30 can be evenly expanded in the best sunscreen or sheltering status thereof. Meanwhile, the walls defining the ventilation hole 32 and the support guide ribs 33 thereof are made in thin plates, which makes the Venetian blind 20 lighter in weight for easier transportation and effortless assembly thereof. Moreover, the ventilation hole 32 and the support guide ribs 33 of the blind slat 30 thereof are integrally made as a whole, facilitating a simpler and speedier processing thereof so as to reduce the cost of production and processing thereof and boost the competitive power of the present invention on the market.

What is claimed is:

1. A slat structure for Venetian blinds, including a Venetian blind made up of rope ladders suspended between an upper and lower beams for supporting a plurality of blind slats located in an equal space thereto, and a pull cord led through cord-passage holes of the blind slats thereof respectively before wound around a pulley seat mounted at one end of the upper beam therein to hang downwards there-from so as to control the raising or lowering of the blind slats thereby wherein each blind slat is made in a hollow shape to form a ventilation hole at the inner side thereof, efficiently providing better heat dissipation and insulation effects thereby as well as avoiding the risk of hardening or warping thereof due to overheating by the sun so that the blind slats can be neatly kept in good shapes and evenly expanded to achieve the best sunscreen or sheltering status; the present invention being also characterized by that,
the ventilation hole of the blind slat having a plurality of support guide ribs properly extending at the inner side and integrally connected with the upper and lower inner walls thereof so as to provide a reinforcing support effect thereby; besides, the walls defining the ventilation hole and the support guide ribs thereof being made in thin plates, which makes the Venetian blind lighter in weight for easier transportation and effortless assembly thereof, and the ventilation hole and the support guide ribs thereof being integrally made as a whole, facilitating a simpler and speedier processing thereof so as to reduce the cost of production and processing thereof and boost the competitive power of the present invention on the market.

2. The slat structure for Venetian blinds as claimed in claim 1 wherein the support guide ribs thereof are vertically extending and integrally connected with the inner walls of the ventilation hole thereof.
